(19) United States
(12) Patent Application Publication
(10) Pub. No.: US 2025/0305557 A1
(43) Pub. Date: Oct. 2, 2025

(54) WHEEL BALANCE WEIGHT COMPOSITION AND A MOLDED PRODUCT THEREOF

(71) Applicants: HYUNDAI MOTOR COMPANY, Seoul (KR); KIA CORPORATION, Seoul (KR)

(72) Inventors: Ho Dong Kim, Yongin-si (KR); Kang Sun Lee, Seongnam-si (KR); Hyung Seok Kim, Gwacheon-si (KR)

(73) Assignees: HYUNDAI MOTOR COMPANY, Seoul (KR); KIA CORPORATION, Seoul (KR)

(21) Appl. No.: 18/794,608

(22) Filed: Aug. 5, 2024

(30) Foreign Application Priority Data
Mar. 28, 2024 (KR) 10-2024-0042703

(51) Int. Cl. F16F 15/32; C08K 3/08; C08K 3/22; C08K 5/092

(52) U.S. Cl. CPC F16F 15/324; C08K 3/08; C08K 3/22; C08K 5/092; C08K 2003/0856; C08K 2003/2296; C08K 2201/005; F16F 2224/005; F16F 2224/0208; F16F 2224/0258

(57) ABSTRACT

A wheel balance weight composition includes an elastomer in an amount of 100 parts by weight, metal oxide in an amount equal to or greater than 1 part by weight and equal to or smaller than 10.5 parts by weight, fatty acid in an amount equal to or greater than 0.5 parts by weight and equal to or smaller than 5.5 parts by weight, and stainless steel (SUS) powder in an amount equal to or greater than 380 parts by weight and equal to or smaller than 1,480 parts by weight.

### CROSS-REFERENCE TO RELATED APPLICATION

This application claims the benefit of and priority to Korean Patent Application No. 10-2024-0042703, filed in the Korean Intellectual Property Office on Mar. 28, 2024, the entire contents of which are incorporated herein by reference.

### TECHNICAL FIELD

The present disclosure relates to a composition that may manufacture a wheel balance weight and a molded product thereof.

### BACKGROUND

A wheel balance weight of a vehicle is mounted on a wheel to maintain dynamic balance between a tire and the wheel, and the wheel balance weight usually keeps balance via an own weight and a mounted location on the wheel. As an existing wheel balance weight, a scheme of attaching a metal weight to the tire or a rim with an adhesive is widely used. However, such existing wheel balance weight using the adhesive has a problem in that an interface between the adhesive and the wheel is peeled or lifted when the wheel balance weight is used for a long time because of a lack of adhesion to an inner curved surface of the wheel caused by a lack of elasticity of the metal weight. In addition, the existing wheel balance weight has a problem of rust and/or corrosion occurring in various environments in which the vehicle travels because of a lack of durability of the metal weight.

As an alternative, research on a wheel balance weight using an elastic body is actively underway. For example, Korean Patent Application Publication No. 1806741 (Patent Document 1) discloses a balancing weight composition containing stainless steel (SUS) powder and a resin base, wherein the resin base contains (1) polyester-based engineering plastic, (2) an epoxy resin, and (3) an ion crosslinked elastomer copolymerized with EPDM rubber and a carboxylic acid monomer having 3 to 10 carbon atoms. However, the existing wheel balance weight using the elastic body such as that in Patent Document 1 has difficulties and limitations in manufacturing a high specific gravity compound wheel balance weight. Specifically, a molded body manufactured from the composition of Patent Document 1 may be difficult to be applied because of a specific gravity thereof equal to or lower than 4.3, which does not satisfy a condition of a specific gravity equal to or higher than 4.5 to be applicable as a wheel balance weight for a vehicle type that requires high precision. In addition, a manufacturing method of Patent Document 1 includes multi-step processes such as a primary resin, powder, and additive mixing process, a secondary pellet processing process, a tertiary molded product manufacturing process, an additional cooling process, and the like. Because of complexity of the processes, it is difficult to secure specific gravity dispersion, so that quality deviation may occur under mass production conditions. Furthermore, the existing wheel balance weight using the elastic body such as that in Patent Document 1 has a rough outer surface, which reduces convenience of operation of an operator and causes poor external appearance and marketability.

### SUMMARY

The present disclosure has been made to solve the above-mentioned problems occurring in the prior art while advantages achieved by the prior art are maintained intact.

An embodiment of the present disclosure provides a composition that may manufacture a wheel balance weight that has excellent marketability because of excellent elasticity and excellent adhesion along an inner curved surface of a wheel, and has excellent workability because cutting is easy compared to an existing steel type and a molded product thereof.

The technical problems to be solved by the present disclosure are not limited to the aforementioned problems, and any other technical problems not mentioned herein should be clearly understood from the following description by those having ordinary skill in the art to which the present disclosure pertains.

According to an embodiment of the present disclosure, a wheel balance weight composition includes: an elastomer in an amount of 100 parts by weight; metal oxide in an amount equal to or greater than 1 part by weight and equal to or smaller than 10.5 parts by weight; fatty acid in an amount equal to or greater than 0.5 parts by weight and equal to or smaller than 5.5 parts by weight; and stainless steel (SUS) powder in an amount equal to or greater than 380 parts by weight and equal to or smaller than 1,480 parts by weight.

According to another embodiment of the present disclosure, a molded product is molded with the wheel balance weight composition.

### BRIEF DESCRIPTION OF THE DRAWINGS

The above and other objects, features and advantages of the present disclosure are more apparent from the following detailed description taken in conjunction with the accompanying drawings:

FIG. 1 is a photo illustrating bendability evaluation results in Examples of the present disclosure.

The drawings described herein are for illustration purposes only and are not intended to limit the scope of the present disclosure in any way.

### DETAILED DESCRIPTION

The present disclosure is described in detail.

Herein, when a certain portion “includes” a certain component, this means that the certain portion may further include other components without excluding said other components unless otherwise stated.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

### Wheel Balance Weight Composition

A wheel balance weight composition according to an embodiment of the present disclosure contains an elastomer, metal oxide, fatty acid, and stainless steel (SUS) powder.

### Elastomer

The elastomer improves durability of a molded product containing the same to allow the molded product to be used in various environments, and improves elasticity of the molded product to improve adhesion along an inner curved surface of a wheel.

Additionally, the elastomer may include one or more selected from a group consisting of an ethylene-based polymer and an acrylic-based polymer. For example, the elastomer may include an ethylene-based polymer, an acrylic-based polymer, or a combination thereof. When the ethylene-based polymer and/or the acrylic-based polymer are used as the elastomer, the manufactured molded product may have excellent elasticity because of excellent mixability with an activator and the stainless steel (SUS) powder. As a result, a problem in which a specific gravity of the manufactured molded product is insufficient as the molded product is physically damaged or the stainless steel powder deviates during manufacturing may be prevented.

In this regard, the elastomer may be rubbery. In other words, the elastomer may include one or more selected from a group consisting of ethylene-based rubber and acrylic-based rubber.

The ethylene-based polymer may include at least one selected from a group consisting of an ethylene propylene diene monomer (EPDM) polymer and an ethylene propylene monomer (EPM) polymer. For example, the ethylene-based polymer may include an ethylene propylene diene monomer (EPDM) polymer, an ethylene propylene monomer (EPM) polymer, or a combination thereof. Specifically, the ethylene-based polymer may be ethylene propylene diene monomer rubber (EPDM) or ethylene propylene monomer rubber (EPM). When the EPDM and/or the EPM are used as the ethylene-based polymer, the manufactured molded product has excellent chemical resistance such as heat resistance, ozone resistance, and weather resistance, and has further improved workability and elasticity.

In addition, the ethylene-based polymer may have a Mooney viscosity equal to or higher than 50, equal to or higher than 55, equal to or higher than 60, equal to or higher than 65, equal to or higher than 70, equal to or lower than 150, equal to or lower than 140, equal to or lower than 130, and equal to or lower than 120 at a ML (1+4) 125° C. condition. When the Mooney viscosity of the ethylene-based polymer is within the above range, there is an effect of improving mixability and miscibility with the stainless steel powder. Further, because the polymer has excellent elasticity, a shape stability of the molded product manufactured therefrom may be improved (e.g., deficiencies in outer appearance characteristics, such as incomplete filling and/or surface cracking do not occur).

Herein, the term “ML (1+4)” can be understood as attained value after 1 minute pre-heating time and 4 minutes test time.

Commercially available products of the ethylene-based polymer may include, for example, KEP270, KEP5770, KEP2380, KEP282F, KEP370F, KEP2480, KEP9520, KEP9590, KEP9570E, and KEP8512 from Kumho Polychem.

The acrylic-based polymer may contain a first repeating unit derived from one or more acrylate monomers selected from a group consisting of an alkyl acrylate monomer and an alkoxy alkyl acrylate monomer (e.g., derived from one or more acrylate monomers including an alkyl acrylate monomer, an alkoxy alkyl acrylate monomer, or a combination thereof), and a second repeating unit derived from one crosslinking monomer selected from a group consisting of a crosslinkable hydroxyl group-containing monomer and a crosslinkable chlorine-containing monomer (e.g., derived from one crosslinking monomer including a crosslinkable hydroxyl group-containing monomer or a crosslinkable chlorine-containing monomer).

Alkyl of the alkyl acrylate monomer may have 1 or more, 10 or less, or 8 or less carbon atoms. For example, the alkyl acrylate monomer may include methyl acrylate, ethyl acrylate, n-propyl acrylate, isopropyl acrylate, n-butyl acrylate, isobutyl acrylate, and n-octyl acrylate.

Alkoxy of the alkoxy alkyl acrylate monomer may have 1 or more, 6 or less, 5 or less, or 4 or less carbon atoms. For example, the alkoxy alkyl acrylate monomer may include 2-methoxyethyl acrylate, 2-ethoxyethyl acrylate, 2-butoxyethyl acrylate, and 3-methoxy propyl acrylate.

A crosslinkable hydroxyl group of the crosslinkable hydroxyl group-containing monomer may be a phenol group. For example, the crosslinkable hydroxyl group-containing monomer may include hydroxystyrene, α-methyl-o-hydroxystyrene, vinyl salicylate, p-isopropenylphenol, allylphenol, and 2,2-(hydroxyphenyl-4-vinyl acetyl) propane.

The crosslinkable chlorine-containing monomer may include, for example, 2-chloroethyl vinyl ether, vinyl chloroacetate, chloromethyl styrene, and allyl chloride.

Additionally, the acrylic-based polymer may additionally contain a third repeating unit derived from a vinyl group-containing monomer. The vinyl group-containing monomer may include a vinyl group-containing nitrile-based monomer, a vinyl group-containing acetate-based monomer, a methacrylic acid alkyl ester-based monomer, and a methacrylic acid alkoxy alkyl ester-based monomer. Specifically, the vinyl group-containing monomer may include acrylonitrile, vinyl acetate, styrene, methyl methacrylate, and methoxyethyl methacrylate.

The acrylic-based polymer may have a Mooney viscosity equal to or higher than 15, equal to or higher than 18, equal to or higher than 20, equal to or higher than 25, equal to or higher than 30, equal to or lower than 80, equal to or lower than 75, equal to or lower than 70, equal to or lower than 60, and equal to or lower than 55 at a ML (1+4) 100° C. condition. When the Mooney viscosity of the acrylic-based polymer is within the above range, dispersibility of the high specific gravity stainless steel (SUS) powder may be more improved, elasticity of the manufactured molded product may be improved, and a shape stability of the product may be improved (e.g., deficiencies in outer appearance characteristics, such as incomplete filling and/or surface cracking do not occur).

Additionally, commercially available products of the acrylic-based polymer may include, for example, AR31, AR51, AR54, AR42W, AR71, AR12, and AR14 from ZEON.

### Metal Oxide

The metal oxide serves to improve the workability of the composition by improving the dispersibility of the stainless steel (SUS) powder in the elastomer of the composition.

When the composition contains the metal oxide, workability may be excellent during post-processing such as an extrusion process because dispersibility of each component in the composition is excellent, and a problem of agglomeration within the elastomer may be prevented because of excellent compatibility.

For example, the metal oxide may be an oxide of a non-ferrous metal, and specifically, may include one or more selected from a group consisting of zinc oxide (ZnO), tin oxide, aluminum oxide, and zirconium oxide. For example, the metal oxide may include zinc oxide (ZnO), tin oxide, aluminum oxide, zirconium oxide, or a combination thereof. More specifically, the metal oxide may include zinc oxide.

The wheel balance weight composition contains the metal oxide in an amount equal to or greater 1.0 parts by weight and equal to or smaller than 10.5 parts by weight based on 100 parts by weight of the elastomer. Specifically, the wheel balance weight composition may contain the metal oxide in an amount equal to or greater than 1.2 parts by weight, equal to or greater than 1.5 parts by weight, equal to or greater than 2.0 parts by weight, equal to or greater than 2.5 parts by weight, equal to or greater than 3.0 parts by weight, equal to or smaller than 10.3 parts by weight, equal to or smaller than 10.1 parts by weight, or equal to or smaller than 10.0 parts by weight based on 100 parts by weight of the elastomer.

When the content of the metal oxide is within the above range, the miscibility between the elastomer and the stainless steel powder is improved, and thus, filling properties of the stainless steel powder is improved, thereby improving the outer appearance characteristics such as reduction of cracking in the manufactured molded product, and preventing deterioration of workability of the composition during mixing caused by agglomeration of the unreacted metal oxide.

### Fatty Acid

The fatty acid serves to improve the workability of the composition by improving the dispersibility of the stainless steel (SUS) powder in the elastomer of the composition.

When the composition contains the fatty acid, the workability during the post-processing such as the extrusion process may be excellent because the dispersibility of each component in the composition is excellent, and the agglomeration within the elastomer may be prevented because of excellent compatibility.

The fatty acid may include, for example, saturated fatty acid having 5 or more, 6 or more, 7 or more, 8 or more, 25 or less, 24 or less, 23 or less, 21 or less, or 20 or less carbon atoms; or unsaturated fatty acid having 10 or more, 11 or more, 13 or more, 15 or more, 25 or less, 24 or less, 22 or less, 21 or less, or 20 or less carbon atoms. Specifically, the fatty acid may include one or more saturated fatty acids selected from a group consisting of caprylic acid (saturated fatty acid with 8 carbon atoms), lauric acid (saturated fatty acid with 12 carbon atoms), myristic acid (saturated fatty acid with 14 carbon atoms), palmitic acid (saturated fatty acid with 16 carbon atoms), stearic acid (saturated fatty acid with 18 carbon atoms), and arachidic acid (saturated fatty acid with 20 carbon atoms) (e.g., one or more saturated fatty acids including stearic acid, caprylic acid, lauric acid, myristic acid, palmitic acid, arachidic acid, or a combination thereof); or one or more unsaturated fatty acids selected from a group consisting of oleic acid (18 carbon atoms), elaidic acid (18 carbon atoms), linoleic acid (18 carbon atoms), and ricinoleic acid (18 carbon atoms) (e.g., one or more unsaturated fatty acids including oleic acid, elaidic acid, linoleic acid, ricinoleic acid, or a combination thereof. More specifically, the fatty acid may include stearic acid.

The wheel balance weight composition may contain the fatty acid in an amount equal to or greater than 0.5 parts by weight and equal to or smaller than 5.5 parts by weight based on 100 parts by weight of the elastomer. Specifically, the wheel balance weight composition may contain the fatty acid in an amount equal to or greater than 0.3 parts by weight, equal to or greater than 0.4 parts by weight, equal to or greater than 0.5 parts by weight, equal to or greater than 0.7 parts by weight, equal to or greater than 0.8 parts by weight, equal to or greater than 1.0 part by weight, equal to or smaller than 5.4 parts by weight, equal to or smaller than 5.3 parts by weight, equal to or smaller than 5.1 parts by weight, or equal to or smaller than 5.0 parts by weight based on 100 parts by weight of the elastomer.

When the content of the fatty acid is within the above range, the miscibility between the elastomer and the stainless steel powder is improved, and thus, the filling properties of the stainless steel powder is improved, thereby improving the outer appearance characteristics such as the reduction of the cracking in the manufactured molded product, and preventing separation of the stainless steel powder as active sites are generated in the elastomer.

### Stainless Steel (SUS) Powder

The stainless steel (SUS) powder plays a role in improving the specific gravity of the molded product, so that the molded product may be applied as a wheel balance weight.

In addition, the stainless steel powder may be used without particular restrictions as long as it may be commonly purchased and/or prepared, and may include, for example, one selected from a group consisting of austenitic stainless steel (SUS 300 series), ferritic stainless steel (SUS 400 series), and martensite stainless steel (SUS 600 series). In other words, the stainless steel (SUS) powder may include austenitic stainless steel, ferritic stainless steel, or martensite stainless steel.

The austenitic stainless steel has excellent toughness and ductility, so that the austenitic stainless steel has an effect of improving mechanical properties of the manufactured molded product when used as the stainless steel powder. For example, representative austenitic stainless steel may be SUS 304, and the austenitic stainless steel may include SUS 309, SUS 310, SUS 314, SUS 330, SUS 303, SUS 316, and SUS 317.

The ferritic stainless steel has magnetic properties, so that the ferritic stainless steel enables an automated wheel-tire assembly process when used as the stainless steel powder. For example, representative ferritic stainless steel may be SUS 430, and the ferritic stainless steel may include SUS 444, SUS 434, SUS 436, SUS 405, and SUS 409.

The martensite stainless steel has excellent strength and corrosion resistance, so that the martensite stainless steel has an effect of improving mechanical and chemical properties of the manufactured molded product when used as the stainless steel powder. For example, the representative martensite stainless steel may be SUS 630, and the martensite stainless steel may include SUS 631.

The stainless steel powder may have an average particle size equal to or greater than 1 μm and equal to or smaller than 1501 μm. Specifically, the stainless steel powder may have an average particle size equal to or greater than 1 μm, equal to or greater than 5 μm, equal to or greater than 10 μm, equal to or greater than 151 μm, equal to or greater than 201 μm, equal to or greater than 301 μm, equal to or smaller than 1501 μm, equal to or smaller than 1401 μm, equal to or smaller than 1351 μm, equal to or smaller than 130 μm, equal to or smaller than 1251 μm, equal to or smaller than 123 μm, or equal to or smaller than 120 μm.

When the average particle size of the stainless steel powder is smaller than the above range, an excess of undispersed particles may occur during the mixing, resulting in quality deviation in which the specific gravity of the manufactured product is not constant. Such quality deviation in the specific gravity of the product may lead to a problem of excessively generating errors in a wheel balancing work, which is a purpose of the present product, caused by dissatisfaction with quality stability of the product during a continuous process. In addition, when the average particle size of the stainless steel powder is excessively small, competitiveness of the product may be weakened during mass production because of a high cost of the powder itself. On the other hand, when the average particle size of the SUS powder exceeds the above range, excessive wear of an extruder cylinder and a screw may occur, resulting in machine depreciation and an increase in material costs. On the other hand, when the average particle size of the stainless steel powder is within the above range, the mixability of the composition is improved, and the specific gravity of the manufactured product is increased by increasing a maximum filling ratio via blending for each size of the SUS powder. In this regard, the “average particle size” may be a particle size of cumulative distribution 50% (D₅₀) in a particle size distribution map measured using a particle size analyzer (PSA).

Additionally, the stainless steel powder may have an apparent density equal to or greater than 3.0 kg/cm³ and equal to or smaller than 8.0 kg/cm³. Specifically, the stainless steel powder may have the apparent density equal to or greater than 3.0 kg/cm³, equal to or greater than 3.5 kg/cm³, equal to or greater than 4.0 kg/cm³, equal to or greater than 4.4 kg/cm³, equal to or greater than 4.5 kg/cm³, equal to or greater than 4.7 kg/cm³, equal to or greater than 4.9 kg/cm³, equal to or smaller than 7.8 kg/cm³, equal to or smaller than 7.5 kg/cm³, equal to or smaller than 7.0 kg/cm³, equal to or smaller than 6.5 kg/cm³, equal to or smaller than 6.0 kg/cm³, or equal to or smaller than 5.5 kg/cm³. When the apparent density of the stainless steel powder is within the above range, radial force variation (RFV) optimization and balancing work errors may be minimized during a tire balancing work using a high specific gravity wheel balance weight prepared containing the stainless steel powder.

The stainless steel powder is contained in a content equal to or greater than 380 parts by weight and equal to or smaller than 1,480 parts by weight based on 100 parts by weight of the elastomer. Specifically, the activator may be contained in an amount equal to or greater than 400 parts by weight, equal to or greater than 450 parts by weight, equal to or greater than 500 parts by weight, equal to or greater than 600 parts by weight, equal to or greater than 650 parts by weight, equal to or greater than 700 parts by weight, equal to or smaller than 1,450 parts by weight, equal to or smaller than 1,430 parts by weight, equal to or smaller than 1,410 parts by weight, or equal to or smaller than 1,400 parts by weight. When the content of the stainless steel powder is within the above range, a problem in which the manufactured molded product is too bulky to be used as the wheel balance weight and thus racket and/or noise occur when a mobility equipped with the same travels and a problem in which the stainless steel powder is separated from the composition during the post-processing or the manufactured molded product is damaged because of lack of the miscibility between the elastomer and the stainless steel powder may be prevented.

The wheel balance weight composition may further contain one additive selected from a group consisting of a crosslinking accelerator and a plasticizer. The crosslinking accelerator may include at least one of a guanidine-based crosslinking accelerator or a carbamate-based crosslinking accelerator.

### Crosslinking Accelerator

The crosslinking accelerator further improves crosslinking properties of the active sites in the composition to improve mechanical strength and elasticity of the manufactured molded product, and improves adhesion between the elastomer and the stainless steel powder.

Additionally, the crosslinking accelerator may be guanidine-based or carbamate-based. For example, the guanidine-based crosslinking accelerator may include di-ortho-tolyl guanidine (DOTG) and 1,3-diphenyl guanidine (DPG). In addition, the carbamate-based crosslinking accelerator may include, for example, hexamethylenediamine carbamate and 4,4′-methylene-bis (cyclohexylamine) carbamate.

Commercially available products of the crosslinking accelerator may include, for example, NOCCELER PZ, NOCCELER TTFE, VULNOC AB, NOCCELER EUR, and NOCCELER DT from Ouchishinko Chemical Industry, and ZEONET A, ZEONET BF, and ZEONET U from Tokyo Zairyo.

The crosslinking accelerator may be contained in an amount equal to or greater than 0.5 parts by weight and equal to or smaller than 2.5 parts by weight based on 100 parts by weight of the elastomer. Specifically, the crosslinking accelerator may be contained in an amount equal to or greater than 0.8 parts by weight, equal to or greater than 0.9 parts by weight, equal to or greater than 1 part by weight, equal to or smaller than 2.4 parts by weight, equal to or smaller than 2.3 parts by weight, equal to or smaller than 2.1 parts by weight, or equal to or smaller than 2.0 parts by weight. When the content of the crosslinking accelerator is within the above range, a problem in which the mechanical strength and the elasticity of the manufactured molded product are insufficient because of insufficient crosslinking properties of the active sites in the composition and a problem in which cracking or breakage occurs during bending because the manufactured molded product has insufficient flexibility may be prevented.

### Plasticizer

The plasticizer improves formative properties of an edge during extrusion molding of the composition and improves extrusion moldability by improving the flexibility of the composition.

In addition, the plasticizer may be used without particular limitations as long as it may be commonly used in rubber or plastic processing, and may include, for example, alicyclic, aromatic, and paraffinic plasticizer, but the present disclosure may not be limited thereto.

An added amount of the plasticizer may be appropriately adjusted depending on a type of the elastomer. For example, the plasticizer may be contained in the composition in an amount equal to or greater than 1 part by weight and equal to or smaller than 28 parts by weight based on 100 parts by weight of the elastomer. Specifically, the composition may contain the plasticizer in an amount equal to or greater than 3 parts by weight, equal to or greater than 5 parts by weight, equal to or greater than 7 parts by weight, equal to or greater than 8 parts by weight, equal to or smaller than 26 parts by weight, equal to or smaller than 25 parts by weight, equal to or smaller than 24 parts by weight, or equal to or smaller than 23 parts by weight, based on 100 parts by weight of the elastomer. When the content of the plasticizer is within the above range, a problem of insufficient outer appearance characteristics of the manufactured molded product caused by insufficient extrusion moldability and edge formative properties, which are resulted from insufficient flexibility of the composition, and a problem in which the extrusion molding is difficult as a flow occurs in a die of an extruder during the molding because of low viscosity of the composition may be prevented.

In addition, the composition may further contain an additive that may be added during the rubber or plastic processing in addition to the crosslinking accelerator and the plasticizer described above. For example, the composition may additionally include a vulcanization accelerator, an anti-aging agent, a processing aid, and a filler.

The wheel balance weight composition as described above has advantages of being environmentally friendly as it does not contain heavy metals, and has excellent workability because of appropriate flexibility and excellent extrusion moldability and edge formative properties.

### Molded Product

The molded product according to an embodiment of the present disclosure is molded with the wheel balance weight composition as described above. In this regard, a molding method may be applied without particular restrictions as long as it is a method that may be generally applied to the rubber or plastic molding. For example, a method of performing the extrusion molding after the mixing with an open mill roll, an internal mixer, or a kneader may be applied, but the present disclosure may not be limited thereto.

The molded product may be the wheel balance weight, and specifically, may be the wheel balance weight for the mobility. In this regard, the mobility may include, for example, a vehicle, an aircraft, a train, a ship, or various mobile robots.

Additionally, the molded product may have a specific gravity equal to or higher than 3.0, equal to or higher than 3.2, equal to or higher than 3.5, equal to or higher than 3.8, equal to or higher than 4.0, equal to or lower than 6.0, equal to or lower than 5.8, equal to or lower than 5.7, equal to or lower than 5.5, equal to or lower than 5.3, or equal to or lower than 5.1. As described above, the molded product has a high specific gravity and thus is suitable for application as the wheel balance weight.

The molded product has excellent marketability because of the excellent elasticity and the excellent adhesion along the inner curved surface of the wheel, and has the excellent workability because cutting is easy compared to an existing steel type. In addition, the molded product has excellent economic efficiency as the manufacturing process may be automated because of the ease of cutting as described above. Furthermore, the molded product is eco-friendly as it does not contain the heavy metals, and is able to be used for a long time in various usage environments because of the excellent durability, chemical resistance, and weather resistance, so that the molded product is very suitable as an automobile part.

Hereinafter, one or more embodiments of the present disclosure are described in more detail via examples. However, these examples are only intended to help understand the present disclosure, and the scope of the present disclosure is not limited to these examples in any way.

### EXAMPLES

### Examples 1 to 6 and Comparative Examples 1 to 8. Preparation Of Compositions

Wheel balance weight compositions were prepared by mixing the components in compositions shown in Table 1 below.

In this regard, the EPDM in Table 1 is the ethylene propylene diene monomer polymer, and KEP2480 [Mooney viscosity: ML (1+4) 125° C., 100±20] from Kumho Polychem was used. In addition, AR12 [Mooney viscosity: ML (1+4) 100° C., 40±10] from ZEON was used as the acrylic-based polymer, and NOCCELER DT from Ouchishinko chemical industry was used as the crosslinking accelerator. Furthermore, GREG G-8205 from Dainippon Ink And chemical was used as the plasticizer, and SUS 630 [particle size: 30 to 1201 μm, apparent density: 5.1 kg/cm³, and tap density: 7.1 kg/cm³] from Daido was used as the stainless steel (SUS) powder.

TABLE 1

| | Elastomer | | | | | | |
|---|---|---|---|---|---|---|---|
| Composition | | Acrylic- | | | | | |
| (parts by | | based | | Stearic | Crosslinking | | SUS |
| weight) | EPDM | polymer | ZnO | acid | accelerator | Plasticizer | powder |
| Example 1 | 100 | 0 | 3 | 1 | 2 | 8 | 700 |
| Example 2 | 50 | 50 | 5 | 3 | 1.5 | 10 | 1,000 |
| Example 3 | 0 | 100 | 3 | 1 | 1.5 | 15 | 1,300 |
| Example 4 | 0 | 100 | 10 | 5 | 1 | 23 | 1,400 |
| Comparative | 100 | 0 | 11 | 0 | 2 | 8 | 800 |
| Example 1 | | | | | | | |
| Comparative | 0 | 100 | 0 | 3 | 1.5 | 10 | 1,000 |
| Example 2 | | | | | | | |
| Comparative | 50 | 50 | 0 | 6 | 1 | 15 | 1,200 |
| Example 3 | | | | | | | |
| Comparative | 100 | 0 | 11 | 3 | 1 | 15 | 1,300 |
| Example 4 | | | | | | | |
| Comparative | 0 | 100 | 5 | 6 | 1 | 23 | 1,400 |
| Example 5 | | | | | | | |
| Comparative | 50 | 50 | 5 | 3 | 2 | 5 | 350 |
| Example 6 | | | | | | | |
| Comparative | 0 | 100 | 5 | 3 | 1 | 25 | 1,500 |
| Example 7 | | | | | | | |
| Comparative | 50 | 50 | 7 | 5 | 0.5 | 30 | 1,700 |
| Example 8 | | | | | | | |
| Example 5 | 0 | 100 | 10 | 5 | 3 | 10 | 1,000 |
| Example 6 | 0 | 100 | 10 | 5 | 1 | 30 | 1,400 |

### Test Example: Measurement of Physical Properties of Compositions and Molded Products

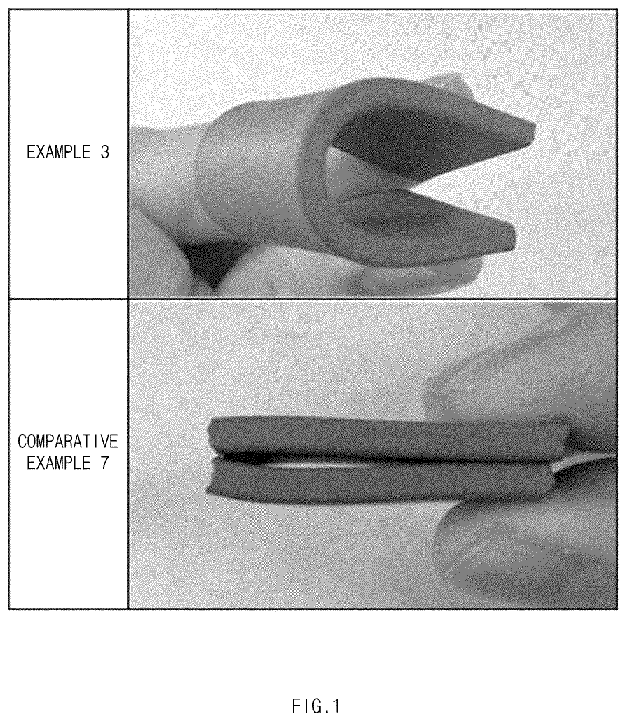

Physical properties of the compositions of Examples and Comparative Examples and molded products manufactured therefrom were measured in a following manner, and the results are shown in Table 2 and FIG. 1.

Specifically, the molded products were manufactured from the compositions of Examples and Comparative Examples via a continuous extrusion method using an extrusion molding machine for rubber materials, and then the molded products were cut to a size of 25 mm×20 mm×3.5 mm (width×height×thickness) to prepare specimens for the physical property evaluation. In this regard, a composition of Example 6 was not able to be molded because a flow of the composition occurred in the die of the extruder during the extrusion.

### (1) Mixing Performance of Composition

Mixing performances of the compositions were measured via a rubber material mixing method using the kneader mixer. Specifically, after mixing each composition with the kneader mixer for one batch, the performance was rated as good when the composition was able to fall below the kneader without any clumping of the SUS powder, rated as fair when the unfilled SUS powder was not in the batch form and clumping of only a small amount (equal to or smaller than 1/10) of the SUS powder occurred, and rated as poor when the SUS powder clumped because of the incomplete filling or an amount of clumped SUS powder exceeds 1/10.

### (2) Bendability

The specimens were able to be bent with a load of 5 kgf, and bendability of the molded products were measured via analysis on changes in outer appearances by 45° bending of the specimens. In this regard, the results of Example 3 and Comparative Example 7 when measuring the bendability are shown in FIG. 1.

Specifically, the bendability was rated as good when there were no cracks in outer surfaces of a center, an edge, and a grip portion after the 45° bending, rated as fair when there were minor cracks in the edge, but there are no problems with functions, and rated as poor when one portion of the specimen was broken or when there was a crack or separation of an adhesion that disables the present function as the wheel balance weight.

### (3) Specific Gravity

Specific gravities of the molded products were measured at 25° C. and 1 atm without an external force applied using a specific gravity meter (electronic densimeter manufactured by ALFA MIRAGE), using a method described in ISO 2781.

### (4) Hydrolysis Resistance

In accordance with ISO 2440, the molded products were kept at 120° C. for 48 hours and then outer appearances of the molded products were observed to evaluate hydrolysis resistances thereof. Specifically, the hydrolysis resistance was rated as good when there were no cracks in the outer surfaces of the center, the edge, and the grip portion of the specimen, rated as fair when there were the minor cracks in the edge, but there are no problems with the functions, and rated as poor when the one portion of the specimen was broken or when there was the crack or the separation of the adhesion that disables the function as the wheel balance weight.

### (5) Salt Water Resistance

In accordance with a salt water resistance evaluation method described in KS D9502, salt water (pH 6.5 to 7.2) at a concentration of 5% by weight was sprayed on the molded products, then the molded products were kept at 35° C. for 720 hours, and then outer appearances of the molded products were observed to evaluate salt water resistances thereof. Specifically, the salt water resistance was rated as good when there were no cracks in the outer surfaces of the center, the edge, and the grip portion of the specimen, rated as fair when there were the minor cracks in the edge, but there are no problems with the functions, and rated as poor when the one portion of the specimen was broken or when there was the crack or the separation of the adhesion that disables the function as the wheel balance weight.

### (6) Weather Resistance

In accordance with a method described in ISO 4892-2, the molded products were exposed to 2500 kJ of energy for 1,200 hours with a xenon weatherometer tester, and then weather resistances were evaluated via outer appearance evaluation. Specifically, the weather resistance was rated as good when there were no cracks in the outer surfaces of the center, the edge, and the grip portion of the specimen, rated as fair when there were the minor cracks in the edge, but there are no problems with the functions, and rated as poor when the one portion of the specimen was broken or when there was the crack or the separation of the adhesion that disables the function as the wheel balance weight.

TABLE 2

| | Mixing | | Specific | Hydrolysis | Salt water | Weather |
|---|---|---|---|---|---|---|
| | performance | Bendability | gravity | resistance | resistance | resistance |
| Example 1 | Good | Satisfactory | 4.01 | Satisfactory | Satisfactory | Satisfactory |
| Example 2 | Good | Satisfactory | 4.51 | Satisfactory | Satisfactory | Satisfactory |
| Example 3 | Good | Satisfactory | 5.03 | Satisfactory | Satisfactory | Satisfactory |
| Example 4 | Good | Satisfactory | 4.91 | Satisfactory | Satisfactory | Satisfactory |
| Comparative | Good | Cracking | 4.25 | — | — | — |
| Example 1 | | small | | | | |
| Comparative | Powder | Cracking | 4.44 | — | — | — |
| Example 2 | separation | great | | | | |
| | medium | | | | | |
| Comparative | Powder | Cracking | 4.62 | — | — | — |
| Example 3 | separation | great | | | | |
| | medium | | | | | |
| Comparative | Powder | Cracking | 4.75 | — | — | — |
| Example 4 | separation | small | | | | |
| | small | | | | | |
| Comparative | Powder | Cracking | 4.78 | — | — | — |
| Example 5 | separation | small | | | | |
| | small | | | | | |
| Comparative | Good | Satisfactory | 2.97 | Satisfactory | Satisfactory | Satisfactory |
| Example 6 | | | | | | |
| Comparative | Powder | Clumping | 4.81 | — | — | — |
| Example 7 | separation | | | | | |
| | medium | | | | | |
| Comparative | Mixing not | — | — | — | — | — |
| Example 8 | possible | | | | | |
| Example 5 | Powder | Cracking | 4.41 | — | — | — |
| | separation | great | | | | |
| | small | | | | | |

| | |
|---|---|
| Example 6 | Poor shape |

As shown in Table 2, it was seen that Examples 1 to 4 are suitable for being applied as the wheel balance weight because they have excellent mixing performances because of excellent mixability and workability during the extrusion, the molded products thereof have excellent bendability, hydrolysis resistance, salt water resistance, and weather resistance, and the specific gravities of the molded products are equal to or higher than 4.

On the other hand, Comparative Examples 1 to 5, 7, and 8 were not able to prepare the specimens, which are the molded products, as the mixing was impossible during the kneader mixing operation and the SUS powder fell in the powder form or the preparation in the complete batch was not performed.

Comparative Example 1, which does not contain stearic acid, which is the fatty acid, had the problem of cracking caused by the bending resulted from the lack of flexibility of the molded product.

In addition, Comparative Examples 2 and 3, which do not contain zinc oxide, which is a metal oxide, Comparative Example 4, which contains an excessive amount of zinc oxide, and Comparative Example 5, which contains an excessive amount of stearic acid, had insufficient mixing performances during the mixing of the respective compositions, and had the problem of cracking caused by the bending resulted from the lack of flexibility of the molded products.

In comparative Example 6, which contains a small amount of SUS powder, the molded product had the specific gravity equal to or lower than 3.0, and thus, was difficult to be applied as the wheel balance weight. In particular, it was determined that a noise will occur when the specimen in Comparative Example 6 is applied as the wheel balance weight because of a lack of the RFV error reduction effect and an increase in a volume caused by the low specific gravity.

In addition, Comparative Example 7, which contains an excessive amount of SUS powder, was damaged during the bending and had insufficient mechanical properties (see FIG. 1), and Comparative Example 8 had insufficient miscibility between the elastomer and the SUS powder, so that they were not able to be formed into the molded products.

The molded product manufactured from the composition according to an embodiment of the present disclosure has the excellent marketability because of the excellent elasticity and the excellent adhesion along the inner curved surface of the wheel, and has the excellent workability because the cutting is easy compared to the existing steel type. In addition, the molded product has the excellent economic efficiency because the manufacturing process may be automated because of the ease of cutting as described above.

Furthermore, the molded product is eco-friendly as it does not contain the heavy metals, and is able to be used for a long time in the various usage environments because of the excellent durability, chemical resistance, and weather resistance, so that the molded product is very suitable as the automobile part.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A wheel balance weight composition comprising:
an elastomer in an amount of 100 parts by weight;
metal oxide in an amount equal to or greater than 1 part by weight and equal to or smaller than 10.5 parts by weight;
fatty acid in an amount equal to or greater than 0.5 parts by weight and equal to or smaller than 5.5 parts by weight; and
stainless steel (SUS) powder in an amount equal to or greater than 380 parts by weight and equal to or smaller than 1,480 parts by weight.

2. The wheel balance weight composition of claim 1, wherein the elastomer includes an ethylene-based polymer, an acrylic-based polymer, or a combination thereof.

3. The wheel balance weight composition of claim 2, wherein the ethylene-based polymer includes an ethylene propylene diene monomer (EPDM) polymer, an ethylene propylene monomer (EPM) polymer, or a combination thereof.

4. The wheel balance weight composition of claim 2, wherein the ethylene-based polymer has a Mooney viscosity equal to or higher than 50 and equal to or lower than 150 at a ML (1+4) 125° C. condition.

5. The wheel balance weight composition of claim 2, wherein the acrylic-based polymer contains a first repeating unit derived from at least one acrylate monomer including an alkyl acrylate monomer, an alkoxy alkyl acrylate monomer, or a combination thereof and a second repeating unit derived from one crosslinking monomer including a crosslinkable hydroxyl group-containing monomer or a crosslinkable chlorine-containing monomer.

6. The wheel balance weight composition of claim 5, wherein the acrylic-based polymer contains a third repeating unit derived from a vinyl group-containing monomer.

7. The wheel balance weight composition of claim 5, wherein the acrylic-based polymer has a Mooney viscosity equal to or higher than 15 and equal to or lower than 80 at a ML (1+4) 100° C. condition.

8. The wheel balance weight composition of claim 1, wherein the metal oxide includes zinc oxide (ZnO), tin oxide, aluminum oxide, zirconium oxide, or a combination thereof.

9. The wheel balance weight composition of claim 1, wherein the fatty acid includes:
at least one saturated fatty acid including stearic acid, caprylic acid, lauric acid, myristic acid, palmitic acid, arachidic acid, or a combination thereof; or
at least one unsaturated fatty acid including oleic acid, elaidic acid, linoleic acid, ricinoleic acid, or a combination thereof.

10. The wheel balance weight composition of claim 1, wherein the stainless steel (SUS) powder includes austenitic stainless steel, ferritic stainless steel, or martensite stainless steel.

11. The wheel balance weight composition of claim 1, wherein the stainless steel (SUS) powder has an average particle size equal to or greater than 1 μm and equal to or smaller than 150 μm.

12. The wheel balance weight composition of claim 1, wherein the stainless steel (SUS) powder has an apparent density equal to or greater than 3.0 kg/cm³ and equal to or smaller than 8.0 kg/cm³.

13. The wheel balance weight composition of claim 1, further comprising:
at least one additive including a crosslinking accelerator, a plasticizer, or a combination thereof, wherein the crosslinking accelerator includes at least one of a guanidine-based crosslinking accelerator or a carbamate-based crosslinking accelerator.

14. The wheel balance weight composition of claim 13, wherein the wheel balance weight composition contains, based on 100 parts by weight of the elastomer, the crosslinking accelerator in an amount equal to or greater than 0.5 parts by weight and equal to or smaller than 2.5 parts by weight and the plasticizer in an amount equal to or greater than 1 part by weight and equal to or smaller than 28 parts by weight.

15. A molded product molded with a wheel balance weight composition, the wheel balance weight composition comprising:
an elastomer in an amount of 100 parts by weight;
metal oxide in an amount equal to or greater than 1 part by weight and equal to or smaller than 10.5 parts by weight;
fatty acid in an amount equal to or greater than 0.5 parts by weight and equal to or smaller than 5.5 parts by weight; and
stainless steel (SUS) powder in an amount equal to or greater than 380 parts by weight and equal to or smaller than 1,480 parts by weight.

16. The molded product of claim 15, wherein the molded product is a wheel balance weight.
